(19) United States
(12) Patent Application Publication
(10) Pub. No.: US 2010/0096018 A1
(43) Pub. Date: Apr. 22, 2010

(54) INSTANT HOT WATER DELIVERY SYSTEM

(76) Inventors: Jacob E. Wylie, San Diego, CA (US); Ronald T. Lane, Redding, CA (US)

Correspondence Address: PATWRITE LLC, 408 W. MAIN ST., MARSHALLTOWN, IA, 50158-5759, US

(21) Appl. No.: 12/647,390

(22) Filed: Dec. 24, 2009

Related U.S. Application Data
(63) Continuation-in-part of application No. 12/389,108, filed on Feb. 19, 2009.
(60) Provisional application No. 61/067,114, filed on Feb. 27, 2008.

(51) Int. Cl. E03B 1/00; F16K 49/00; F24H 1/10

(52) U.S. Cl. 137/2; 137/337; 392/465

(57) ABSTRACT

An instant hot water delivery system for efficiently heating water when necessary to provide instant hot water to a faucet. The instant hot water delivery system generally includes a water heater including an inlet and an outlet, a cold water supply line introducing cold water into the inlet, a hot water supply line connecting the outlet to a faucet and a recirculation line connected to the hot water supply downstream of the outlet and the cold water supply line upstream of the inlet. The recirculation line forms a first recirculation loop for water within the water heater to flow during a first water heating process. A recirculation pump is connected to the cold water supply line between the recirculation line and the inlet for circulating the water during the water heating process. In one embodiment, the control unit is used to retrofit an existing gas or electric water heater.

### CROSS REFERENCE TO RELATED APPLICATIONS

This is a continuation in part of U.S. patent application Ser. No. 12/389,108, filed Feb. 19, 2009, which in turn claims priority to Provisional Application Ser. No. 61/067,114, filed on Feb. 27, 2008, the complete disclosures of each of which are hereby incorporated by reference.

### BACKGROUND OF THE INVENTION

Any discussion of the related art throughout the specification should in no way be considered as an admission that such related art is widely known or forms part of common general knowledge in the field.

Hot water heaters have been in use for years and are used in many homes and buildings. Generally, however, prior hot water heaters have lacked in various areas. One problem currently exists and is noticeable when an individual turns on the hot water faucet to get hot water. Generally, the user must wait several seconds for the hot water to arrive, wherein during that time, cold or warm water flows through the faucet. This can cause a large amount of water waste, especially when multiplied by thousands of homes all experiencing the same problem.

Another problem with current water heaters is that the water heater generally maintains a constant hot temperature of the water within the water heater tank at all times, thus wasting energy during the times when the user does not desire or need hot water, such as but not limited to when the user is sleeping, at work, or on vacation. This can drastically increase energy costs, as well as waste electricity. Because of the inherent problems with the related art, there is a need for a new and improved instant hot water delivery system for efficiently heating water when necessary to provide instant hot water to a faucet.

### SUMMARY OF THE INVENTION

An instant hot water delivery system for efficiently heating water when necessary to provide instant hot water to a faucet. The instant hot water delivery system generally includes a water heater including an inlet and an outlet, a cold water supply line introducing cold water into the inlet, a hot water supply line connecting the outlet to a faucet and a recirculation line connected to the hot water supply downstream of the outlet and the cold water supply line upstream of the inlet. The recirculation line forms a first recirculation loop for water within the water heater to flow during a first water heating process. A recirculation pump is connected to the cold water supply line between the recirculation line and the inlet for circulating the water during the water heating process. In one embodiment, the control unit is used to retrofit an existing gas or electric water heater.

The general purpose of the present invention is to provide an instant hot water delivery system that has many of the advantages of the water heater systems mentioned heretofore. The invention generally relates to a water heater system which includes a water heater including an inlet and an outlet, a cold water supply line introducing cold water into the inlet, a hot water supply line connecting the outlet to a faucet and a recirculation line connected to the hot water supply downstream of the outlet and the cold water supply line upstream of the inlet. The recirculation line forms a first recirculation loop for water within the water heater to flow during a first water heating process. A recirculation pump is connected to the cold water supply line between the local recirculation line and the inlet for circulating the water during the water heating process.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an instant hot water delivery system for efficiently heating water when necessary to provide instant hot water to a faucet.

Another object is to provide an instant hot water delivery system that reduces energy consumption and water usage.

Another object is to provide an instant hot water delivery system that may be retrofitted to an existing water heater system or installed with a new hot water system.

An additional object is to provide an instant hot water delivery system that only heats the water during specific preprogrammed times and days.

A further object is to provide an instant hot water delivery system that includes a local recirculation method to quickly heat the water within the system.

Another object is to provide an instant hot water delivery system that may be used in commercial or residential properties.

Another object is to provide an instant hot water delivery system that provides nearly instant hot water to a water usage location, such as a faucet.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a diagram of the present invention illustrating the first recirculation loop in use.

FIG. 2 is a diagram of the present invention illustrating the second recirculation loop in use.

FIG. 3 is a diagram of the present invention normal use of the water lines flowing to the faucet.

FIG. 4 is a front view of an illustrative control unit.

FIG. 5 is a flowchart of the first and second heating processes.

FIG. 6 is a flowchart of the heating schedule.

FIG. 7 is a diagram of the present invention illustrating the first recirculation loop in use in a retrofitted application.

FIG. 8 is a diagram of the present invention illustrating the second recirculation loop in use in a retrofitted application.

FIG. 9 is a diagram of the present invention illustrating a normal use of the water lines flowing to the faucet in a retrofitted application.

FIG. 10 is a diagram of the present invention in a factory installed configuration in a gas hot water heater.

FIG. 11 is a diagram of the present invention in a factory installed configuration in an electric hot water heater

FIG. 12 is a diagram of the present invention in a retrofitted configuration in a gas hot water heater.

FIG. 13 is a perspective view of a control unit according to an embodiment of the present invention.

FIG. 14 is an illustration of a control unit for use in an electric hot water heater according to an embodiment of the present invention.

FIG. 15 is a diagram of the present invention as applied to a tankless water heating system.

FIG. 16 is a diagram of the present invention operating without a local recirculation loop.

FIG. 17 is a diagram of the present invention illustrating in a pre-plumbed application.

FIG. 18 is a diagram of the present invention illustrating an alternative location for a recirculation pump.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

A. Overview

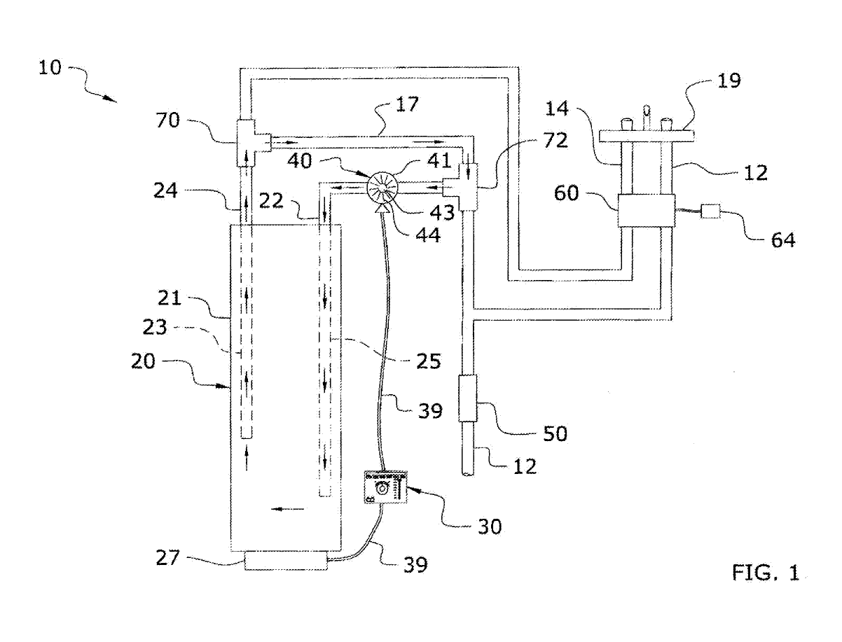

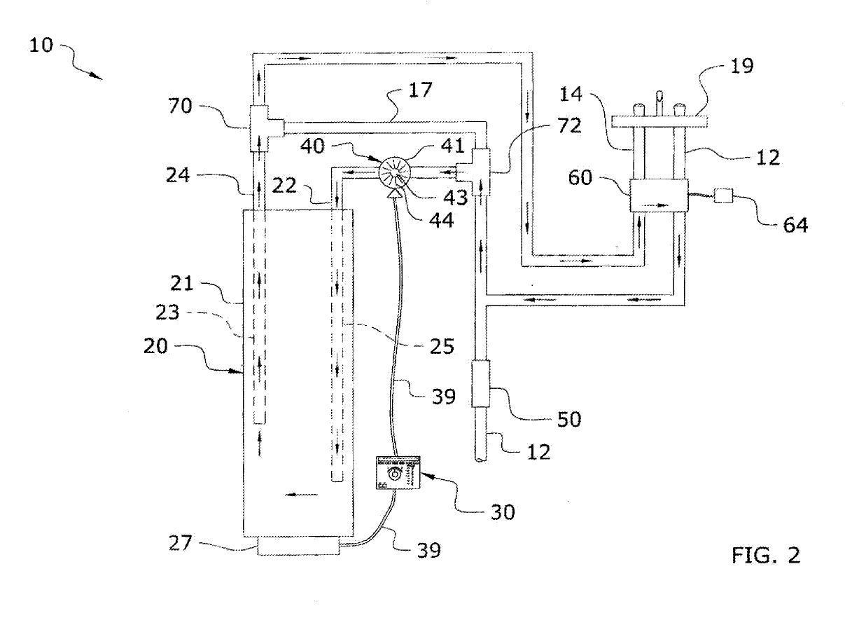

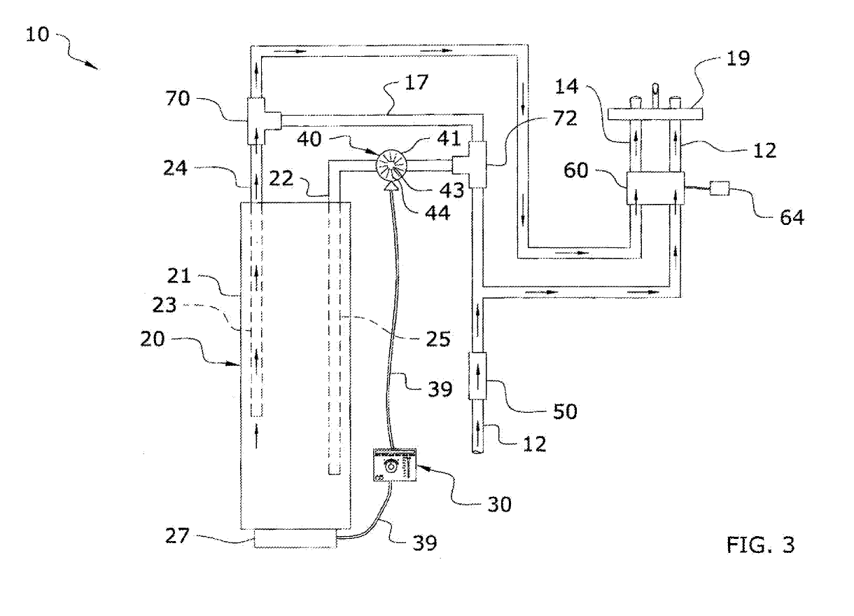

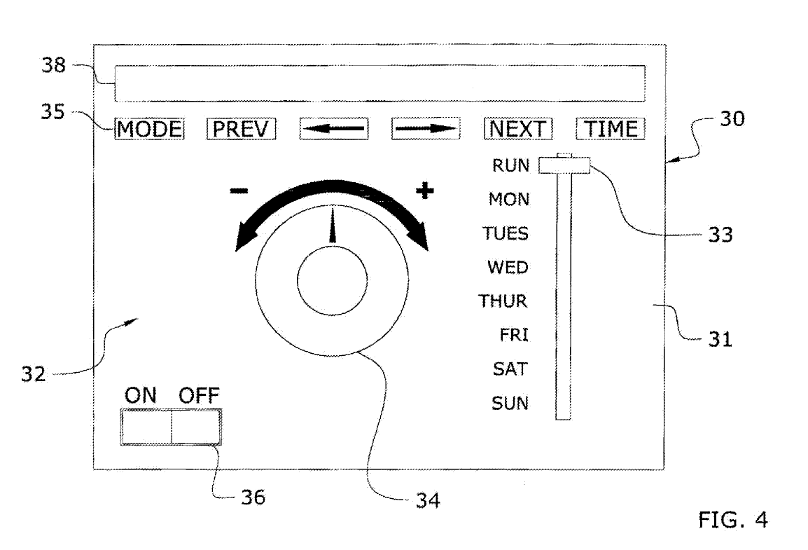

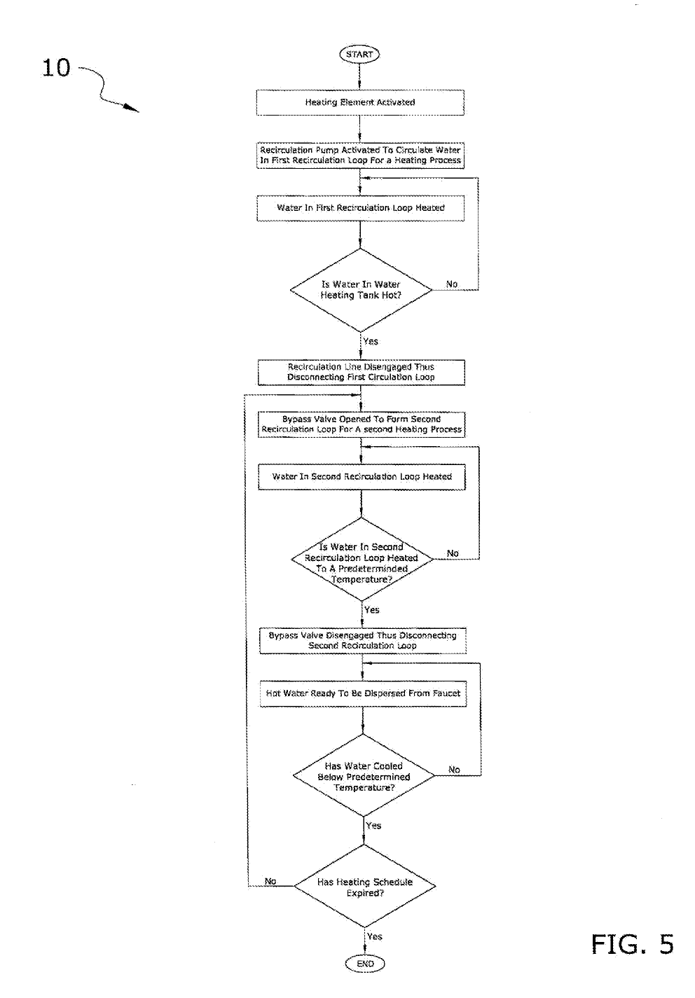

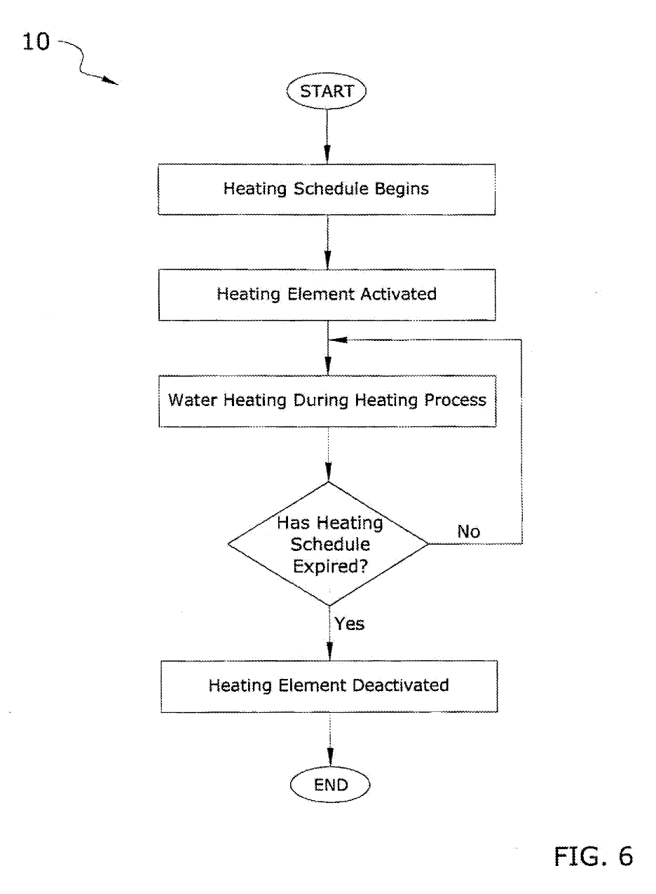

FIGS. 1 through 6 illustrate an instant hot water delivery system 10, which comprises a water heater 20 including an inlet 22 and an outlet 24, a cold water supply line 12 introducing cold water into the inlet 22, a hot water supply line 14 connecting the outlet 24 to a faucet 19 and a recirculation line 17 connected to the hot water supply line 14 downstream of the outlet 24 and the cold water supply line 12 upstream of the inlet 22. The recirculation line 17 forms a first recirculation loop for water within the water heater 20 to flow during a first water heating process. A recirculation pump 40 is connected to the cold water supply line 12 between the local recirculation line 17 and the inlet 22 for circulating the water during the water heating processes.

B. Hot Water Heater

The hot water heater 20 is used to heat and possibly store the water in the system. The hot water heater 20 generally includes an insulated tank 21, a heating element 27, a pressure relief valve and a thermostat among other electrical and mechanical components common to hot water heaters, such as but not limited to a sacrificial anode to prevent corrosion of the tank, drain valves, and shutoff valves. The hot water heater 20 may be preexisting or may be newly installed with the present invention, as well as any other components described herein that assist in the function of the present invention.

It is appreciated that the hot water heater 20 may by a tank style, as described above, or tankless style configuration. The heating element 27 may be comprised of an electric heating element 27 or a gas burner and valve configuration. Other configurations may also be utilized for the heating element 27 all of which heat the water within the hot water heater 20. The pressure relief valve prevents over pressurization of the tank 21, wherein the relief valve will open when the tank 21 exceeds a certain threshold. The relief valve exists to prevent the tank 21 from over pressurizing and possibly rupturing. The thermostat is used for regulating the temperature of the water within the tank 21.

It is appreciated that the tank style water heater also generally has first dip tube 25 for allowing cold water to enter the tank 21 through the inlet 22 and a second dip tube 23 for allowing hot water to exit the tank 21 through the outlet 24. Since cold water is denser than hot water, the cold water dip tube 23 extends deeper into the tank 21 than the hot water dip tube 25.

It is appreciated that in a tankless water heater system, a heating element 27 is generally used with a heat-exchanging interface for transferring heat to the water in the form of coils, etc., and a flow sensing and controlling device is used to sense the flow of water through the heat-exchanging interface and to enable the heating element 27. The coils are generally comprised of highly conductive material for quickly and efficiently heating the water. Various other configurations of hot water heaters 20 may be used and integrated with the present invention.

C. Control Unit

The present invention includes a control unit 30 to control when the hot water heater 20 is heating the water via the heating element 27 and to turn the pump 40 on and off. The control unit 30 includes a user interface 32 and a display 38, such as a digital LCD display that can show numbers, pictures, letters, etc., for allowing the user to program water heating schedules, recirculation pump 40 shutoff temperatures, recirculation pump 40 timeouts, water heater set temperatures, recirculation pump 40 speeds, heating element 27 on and off positions, activation of the three-way valves 70, 72 and bypass valves 60, and various other settings. The control unit 30 may connect to the various components of the present invention remotely, through connecting wires 39 or various other means.

The user interface 32 preferably includes, but is not limited to, a keypad, rotating knob 34 for increasing or decreasing a setting, buttons 35 including left, right, previous, and next cursor arrows, time and mode buttons 35, on and off switches 36, slider bar 33 for selecting the day of the week for hot water scheduling, or anything else that allows for control of the control unit 30. The control unit 30 also is able to communicate with and/or control the hot water heater 20, the recirculation pump 40, the bypass valves 60, pump enable units 64, and various other electrical circuitry of the present invention.

The heat scheduling feature of the control unit 30 allows for the user to program what times and days to heat the water within the tank 21 of the hot water heater 20. During non-use hours, the water heater 20 will be set to an idle state where the water is not heated at all or is only heated minimally to prevent freezing. It is appreciated that the scheduling control may not be necessary with a tankless water heater 20. The control unit 30 may also communicate or receive signals from the thermostat within the hot water heater 20.

The control unit 30 may also include various safety features, such as shutoff timeouts for recirculation times, battery backup in case of power failure, audible alarms for over-temperature conditions, etc. The control unit 30 may also be surrounded by an enclosure 31 for protection, wherein the enclosure 31 is water resistant. The control unit 30 may further include a cover panel or other locking mechanism to prevent tampering with the control unit 30.

D. Recirculation Pump

The present invention includes a recirculation pump 40 for transferring the water through the pipes. The recirculation pump 40 is generally comprised of, but is not limited to, a centrifugal configuration and includes a motor 43, which may be electrically powered or may be powered through other means, connected to an impeller 44 for transporting the water or other fluid. The pump also includes an enclosure 41 through which the water flows to contact the impeller 44 and to which connects the pump to the adjacent pipes. The recirculation pump 40 may further have a temperature sensor embedded which tells the control unit 30 when the water in the recirculation loop has reached the desired temperature and therefore when to turn the recirculation pump 40 off. The recirculation pump 40 is used during both heating processes (first and second) and is fluidly connected to both the first recirculation loop and the second recirculation loop.

E. Pump Enable Units

Various pump enable units 64 may also exist to activate the recirculation pump 40. The pump enable units 64 may consist of push buttons, switches, or another kind of interface that enables the activation of the recirculation pump 40. In the case of a single recirculation loop in the hot water network, there could be only one pump enable unit 64 that initiates recirculation, or there could be a pump enable unit 64 at each water usage location (e.g. near the faucet 19, etc.) where nearly instant hot water is desired.

In the case where multiple recirculation loops and bypass valves 60 are utilized, there would generally be a pump enable unit 64 at each water usage location. In addition to enabling the recirculation pump 40, the pump enable units 64, conjunction with the bypass valves 60, may relay information to the control unit 30 indicating when to turn the recirculation pump 40 off, such as when the water in the recirculation loop has reached the desired temperature.

The pump enable units 64 may be hard wired to the control unit 30 or have remote capability. The pump enable units 64 may further be integrated with the bypass valves 60 and/or mounted separately at water usage locations. The pump enable units 64 may also have circuitry that communicates temperature information at the bypass valves 60 back to the control unit 30. The pump enable units 64 may control the recirculation pump 40 via communicating information to the control unit 30 or may directly control the recirculation pump 40. The pump enable units 64 may further control the bypass valves 60.

The pump enable units 64 may have various mounting features, such as adhesive material, fasteners, or the like. The pump enable units 64 also include a water resistant enclosure and include various programming features, such as shut-off temperature, remote control communication frequency and various others. The pump enable units 64 may further have a visual readout for viewing the water temperature in their respective bypass valve 60 or in the recirculation loop.

F. Check Valve

The present invention may include a check valve 50 positioned before the recirculation pump 40 in the flow of the cold water supply to the hot water heater 20. The check valve 50 is also positioned upstream of the point of interconnection of the recirculation line 17 and the cold water supply line 12. The purpose of the check valve 50 is to prevent water in the recirculation loop 17 from back flowing into the cold water supply 12.

The check valve 50 is constructed to allow the water to flow only in one direction. The check valve 50 may be comprised of various configurations, such as a ball and spring style where the ball rests in a pocket on one side of the valve and is held in that pocket on the other side by a compression spring. When water pushes against the ball from the pocket side of the valve, the ball moves out of the pocket and compresses the spring thus allowing water to flow through the valve. If water attempts to flow in the other direction, the spring extends and the ball seals itself inside the pocket preventing flow through the valve. Other types of check valves 50, such as a gate style, may be appreciated as well.

G. Bypass Valves

The present invention may also include bypass valves 60 connected between the cold and hot water supply lines 12, 14. The bypass valves 60 are further preferably located at the water usage locations, such as under a sink or faucet 19. The bypass valves 60 may further be located at several water usage locations, or alternatively, only used at the end of the hot water run to provide near instant hot water for the entire network of water lines and be mounted in various manners, such as but not limited to a wall or a pipe. The bypass valves 60 are used when it is desired to recirculate the water throughout the system when heating the water. When the bypass line is activated or open, the hot water supply line 14 flows into the cold water line 12 creating a recirculation loop (i.e. second recirculation loop). When the water at the bypass valve 60 reaches a certain temperature, the recirculation pump 40 and bypass valve 60 are deactivated for nearly instant hot water at the faucet 19 or water usage location. This feature saves water by preventing the user from letting cold water flow down the drain while waiting for hot water.

The bypass valves 60 may be comprised of various types of two-way valves, such as but not limited to diaphragm type, ball valve variation, or gate valve variation. The bypass valves 60 may further have integrated temperature sensors within to signal the control unit 30 when to turn off the recirculation pump 40 once the water temperature reaches a certain threshold. The bypass valves 60 may also include buttons or controls to enable the recirculation pump 40. It is appreciated that the bypass valves 60 should only be used when the hot water network is not pre-plumbed for recirculation.

The bypass valve 60 may further be operated either electrically via a solenoid, etc. or manually. If powered electrically, the bypass valve 60 is generally plugged into an AC wall socket or powered via batteries. The bypass valve 60 may further be configured in various manners, such as but not limited to as a diaphragm style valve, a ball valve, a gate valve, or any other type of valve using a two-way application. The bypass valve 60 may further have various types of functionality, such as to control the shut off temperature of the bypass valve 60, or the speed of the recirculation pump 40.

Further, the bypass valve 60 may have an audible and/or visual alarm to notify the user when the water has reached the shut off temperature and when the recirculation pump 40 has turned off. It is appreciated that the bypass valve 60 may further be comprised of a passive configuration.

The bypass valve 60 forms the second recirculation loop for water within the water heater to flow during a second water heating process. The second recirculation loop formed by the bypass valve 60 covers a larger fluid area than the first recirculation loop. The second recirculation loop is also separate than the recirculation line 17 of the first recirculation loop. The second recirculation loop preferably includes the cold and hot water supply lines 12, 14, the water tank 21 and all parts in the flow thereof except the recirculation line 17. The first recirculation loop thus includes the water tank 21 of the hot water heater 20, the recirculation line 17 and the parts of the lines of the cold and hot supply lines 12, 14 interconnected therebetween.

As opposed to an electrically operated bypass valve 60, the other option is to have a temperature activated valve that closes on its own when the water flowing through it reaches a certain temperature. This valve will open back up when the water cools down. In line with the temperature activated valve could be a check valve to prevent flow in the opposite direction.

In conjunction with the temperature-activated valve 60, the recirculation pump 40 could have but is not limited to a paddle wheel flow meter or pressure transducer connected to it. When the temperature actuated bypass valve 60 closes, the flow meter would sense either that flow had stopped or the pressure transducer would register a spike in water pressure. A signal would then be sent to the system control unit 30 to turn the recirculation pump 40 off. The pump 40 will be turned on briefly in arbitrary intervals to see if the temperature activated bypass valve 60 is open. If the pressure spikes or the flow is zero that means the bypass valve 60 is closed and the pump 40 will immediately turn off. Otherwise the pump 40 will continue running until hot water reaches the temperature operated bypass valve 60 and causes it to close again.

If a temperature activated bypass valve is used instead of an electrically operated bypass valve, pump enable units 64 will not be necessary. The change in pressure or flow is what is used to monitor the state of the temperature activated bypass valve, and there is no need for user interaction.

There are a few advantages to using the temperature operated bypass valve. A first advantage is that the temperature activated bypass valve 60 is a passive device that does not require power or communication means with the system control unit 30. Another advantage is that because the temperature activated bypass valve 60 is a passive device it is easier to install and much cheaper to make than the electrically activated version. Another advantage is that because of the cost saving, the temperature bypass valve 60 makes the overall recirculation system 10 more economically viable.

H. Three-Way Valves

The present invention may include multiple three-way valves 70, 72 to change from a first recirculation loop to a second recirculation loop, or back to an original flow setting. The three-way valves 70, 72 are generally only used when the hot water heater 20 includes a tank 21. Tankless water heaters do not need three-way valves since they only heat water when flow is initiated. The three-way valve can be comprised of multiple valve configurations, such as a ball valve, gate valve, diaphragm valve, electrically powered solenoid valves, or various others.

The three-way valve 70 generally includes an inlet, a first outlet, and a second outlet. The inlet is connected to the hot water supply line 14 coming from the water heater 20. The normally open first outlet is connected to the hot water network and the normally closed second outlet is connected to the quick reheat recirculation line 17, which is plumbed into the cold water supply line 12 going into the water heater 20 to form the first recirculation loop. When both three-way valves 70, 72 and the recirculation pump 40 are enabled, water recirculates through the water heater tank 21 via the second outlet causing the water to heat up quicker. When the hot water heater 20 is scheduled to begin reheating after a long period of inactivity, the three-way valves 70, 72 and the recirculation pump 40 are activated to create the first recirculation loop to heat the water in the tank 21 more quickly.

A variation of usage of the local recirculation loop is where the tank 21 includes two outlets 24 rather than one. The first outlet line is used to supply hot water to the water usage network, and the second outlet is used for the sole purpose of quickly reheating the tank 21. The second outlet may be tied into the cold water supply just upstream of the recirculation pump 40.

During normal operation, when hot water is being supplied to the water usage network, the bypass valve 60 is open and the three-way valves 70, 72 are closed. Then, when tank 21 regeneration is desired, the bypass valve 60 is closed and the three-way valves 70, 72 are open, thus allowing water to quickly recirculate through the tank 21 and heat up quickly.

I. Installation of Preferred Embodiment

During installation of the present invention, the system is installed in a pre-existing water heating setup or with a new water heating setup. The outlet 24 or hot water supply line 14 adjacent the outlet 24 of the water heater 20 first connects to the three-way valve 70. The normally open port of the three-way valve 70 then connects to the hot water supply line 14, which distributes hot water to each water usage location. The normally closed port of the three-way valve 70 is connected to the local recirculation line 17 for quick reheating which tees into the cold water supply line 12, via another three-way valve 72, upstream of the recirculation pump 40 and downstream of the cold water check valve 50.

If the pre-existing water heating system is plumbed for hot water recirculation, all hot water usage points are interconnected by a single pipe loop, which is tied into the cold water supply line 12, just upstream of the recirculation pump 40. It is appreciated that in place of the additional three-way valve 72, the check valve 50 may be used or any type of valve to prevent the water from the local recirculation line 17 from back flowing into the cold water supply line 12. The recirculation pump 40 can be placed near or far from the hot water heater 20 or may be an integral part of the hot water heater 20. The recirculation pump 40 is plumbed in line with the cold water supply line 12.

The pump enable units 64 may be placed at various locations, and are preferably located near the water usage points. The bypass valve 60, if not already connected, is connected preferably near the water usage point between hot water supply line 14 and the cold water supply line 12 to selectively form the second recirculation loop between the hot and cold water supply lines 12, 14. It is appreciated that the pump enable unit 64 may be integrated with the bypass valve 60. In alternative to the bypass valve 60, the end of the hot water supply line 14 may be connected to the water heater inlet 22 to form the second recirculation loop.

J. Operation of Preferred Embodiment

Once setup is complete, the control unit 30 is configured. The correct current time is ensured to be set upon the control unit 30. Then, the water-heating schedule may be specified. This is done by programming the times of day for which the water heater should be heating water. The same heating schedule can be set for each day of the week, or be unique for each day. The scheduling feature of the control unit 30 may also have features for setting vacation days where the water heater does not heat at all.

The desired heating temperature may also be set with the control unit 30. The heating temperatures may include the desired temperature of the water within the tank 21, the recirculation shut-off temperatures, and the water temperature at the quick reheat points. Various other settings and synchronizations may also be set with the control unit 30.

The system is now ready for operation. At the start of the heating cycle, the three-way valve 70 on the hot water outlet 24 line toggles thus forming the first recirculation loop via fluidly connecting to the local recirculation line 17. The additional three-way valve 72 connected to the cold water supply line 12 upstream or the recirculation pump 40 also toggles. The recirculation pump 40 then turns on and recirculates water through the tank 21 causing the water to reach the desired set temperature much quicker. It is appreciated that the heating element 27 is turned on at this time. The heating element 27 may be set at a higher than normal level for even 29 faster hot water regeneration. This reheat step could be automatically initiated later on in the heating cycle if the hot water in the tank 21 is depleted due to overuse. This reheat step is also referred to as the first heating process. If a tankless water heater is used, the local recirculation loop 17 will not be a part of the system 10.

Once the water is sensed to be at a desired temperature within the first recirculation loop, the control unit 30 changes modes to form a second recirculation loop and the first heating process ends and the second heating process begins. During the second heating process, the bypass valve 60 is opened connecting the hot water supply line 14 and the cold water supply line 12 at the water usage point and toggling the two three-way valves 70, 72 back to an initial position, thus cutting off the local recirculation line 17. The water then flows through the second recirculation loop to continue heating until the desired temperature has been reached via a sensor in the bypass valve 60, pump enabling unit 64, or other location.

Once the water is heated to a desired temperature, the control unit 30 signals the recirculation pump 40 to turn off and the bypass valve 60 toggles back to an initial position in which to connect the cold and hot water supply lines 12, 14 to their respective lines leading to the faucet 19. Now, when the user opens the hot water valve of the faucet 19, the user should receive nearly instant hot water out of the faucet 19.

As time passes, and still within the heating schedule time, the water cools down, thus forcing the present invention back into heating the water. The recirculation pump 40 turns on and the bypass valve 60 toggles thus putting the water lines 12, 14 into the second recirculation loop. When the water is back at the desired temperature, the bypass valve 60 toggles back to an initial position to connect the water lines to the faucet 19. At the end of the heating schedule, the control unit 30 goes into an idle mode and the heating element 27 turns off to await the next preset heating schedule.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

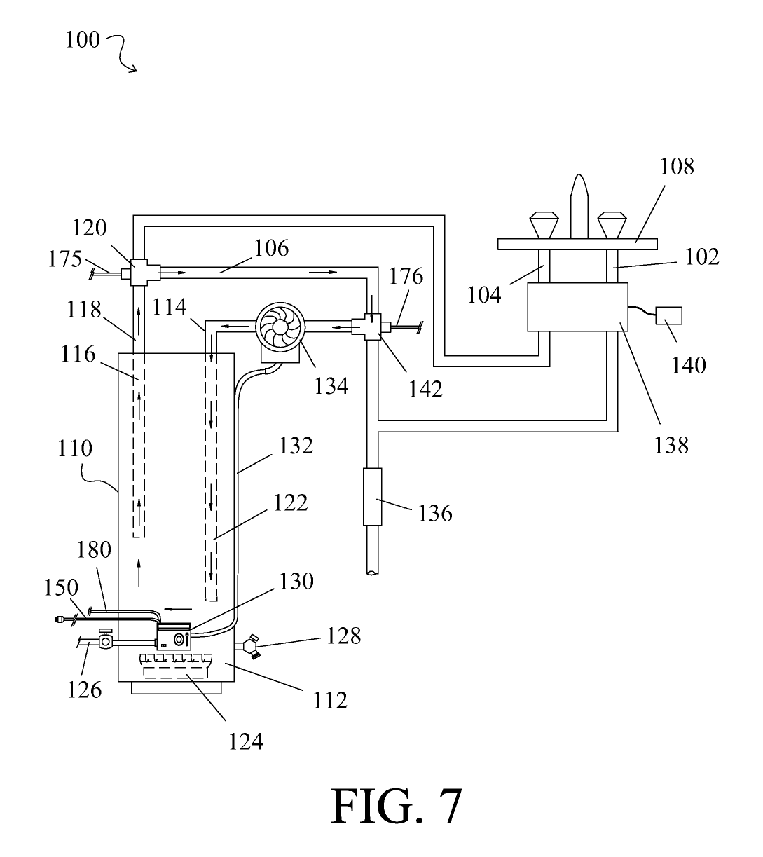

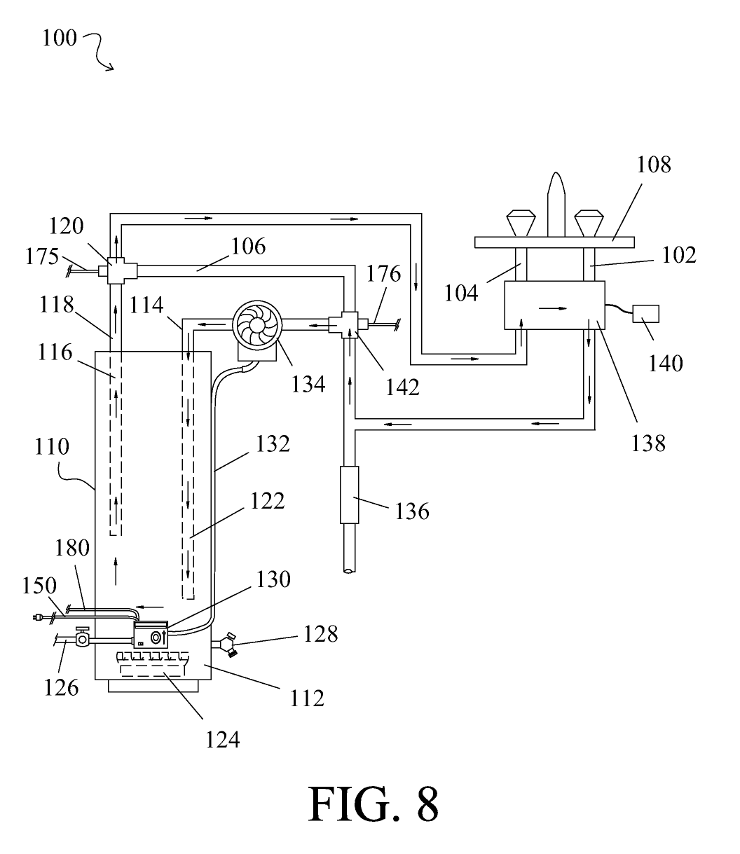

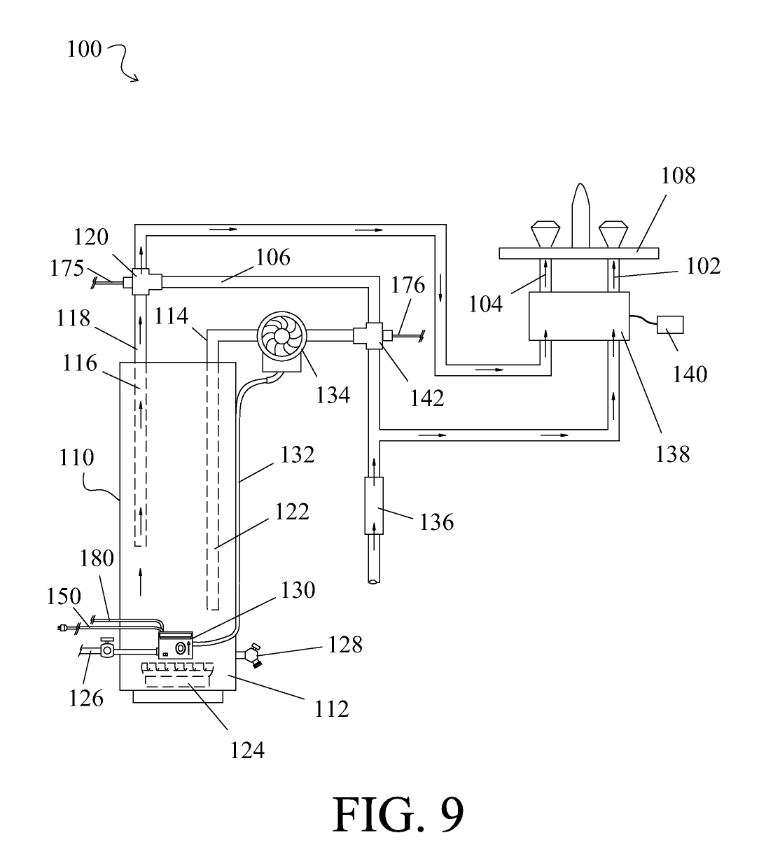

Referring now to FIGS. 7-9, an instant hot water delivery system 100 is shown having a tank 110, with an inlet 114 and outlet 118, a cold water supply line 102 introducing cold water into the inlet 114, a hot water supply line 104 connecting the outlet 118 to a faucet 108 and a recirculation line 106 connected to the hot water supply line 104 downstream of the outlet 118 and the cold water supply line 102 upstream of the inlet 114. The recirculation line 106 forms a first recirculation loop for water within the water tank 112 to flow during a first water heating process. A recirculation pump 134 is connected to the cold water supply line 102 between the local recirculation line 106 and the inlet 114 for circulating the water during the water heating processes.

Instant hot water delivery system 100 is shown as a retrofit application by replacing a standard control unit/thermostat (not shown) with a control unit 130 which includes an electric feed 150 which can either be plugged into a power outlet (not shown) or hard-wired to an electric supply (not shown) as is known in the art. An electrical connector 132 is used to transmit control signals to recirculation pump 134 which turns pump 134 on and off according to selected criteria as described above. Of course a wireless connector could be used to transmit control signals as well as is known in the art as long as control unit 130 is enabled to control the flow of water through system 100.

In the embodiment shown, a gas fired burner 124 is provide to heat the water and flows out of tank 110 in a first dip tube 116. Cold water is introduced into tank 110 using a second dip tube 122. A gas supply line 126 is provided to provide gas to burner 124. Burner 124 may use an “always on” pilot light or may utilize electronic ignition to light burner 124 as is known in the art. In this retrofitted embodiment, an original control unit/thermostat (not shown) is removed and replace with control unit 130. All electrical connections necessary to safely operate the heater are provided along with instructions to aid a user in making the switch.

Tank 110 is provided with a drain valve 128 and a pressure relief valve (not shown) as is known in the art. A bypass valve 138 and pump enable unit 140 are provided to control water flow as discussed above. Also included is a check valve 136 and three way valves 120 and 142 respectively which work together to control the water flow through system 100 as discussed above. First three way valve 120 is electrically controlled by a connection 175 which is electrically connected to control unit 130 through a control connection 180. Second three-way valve 142 is likewise is electrically controlled by a connection 176 also electrically connected to control unit 130 through control connection 180. Of course, the electrical connection may also be a wireless connection using a receiver and transmitter. Additionally, three-way valves 120 and 142 respectively may be passively controlled in response to water temperature without the need for a controlling signal. In such an embodiment, the three-way valves would include a temperature sensor to control their operation. Additionally, bypass valve 138 may also be independently operated by including a temperature sensor as described above.

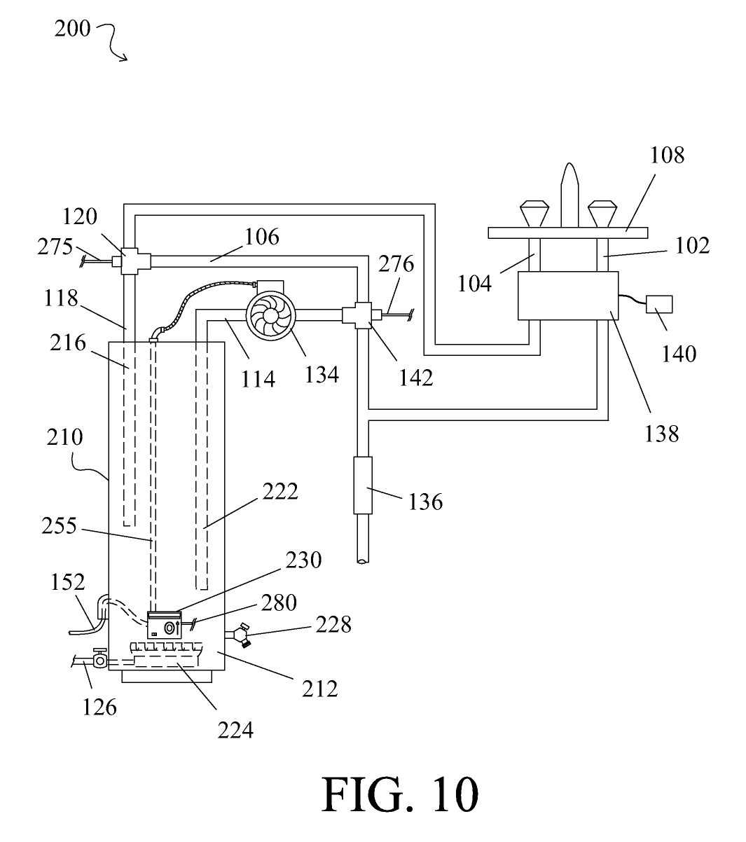

Now referring to FIG. 10, an instant hot water delivery system 200 is shown in a factory assembled embodiment where a recirculation pump wire 255 is shown mounted in an interior portion of tank 212 of a water heater 210. As discussed above, water heater 210 has a first dip tube 216 and a second dip tube 222. A control unit 230 is factory installed and connected to a power source (not shown) with electric feed 152 when installed. Water heater 210 is gas operated and includes a burner 224 and a drain valve 228. As discussed above, first three-way valve 120 includes an electrical connection 275 to control unit 230 through connection 280. Again as discussed above, this connection could be wired or wireless. Likewise, second three-way valve 142 has an electrical connection 276. As above, these valves could also be controlled in response to temperature without the need to be connected to control unit 230.

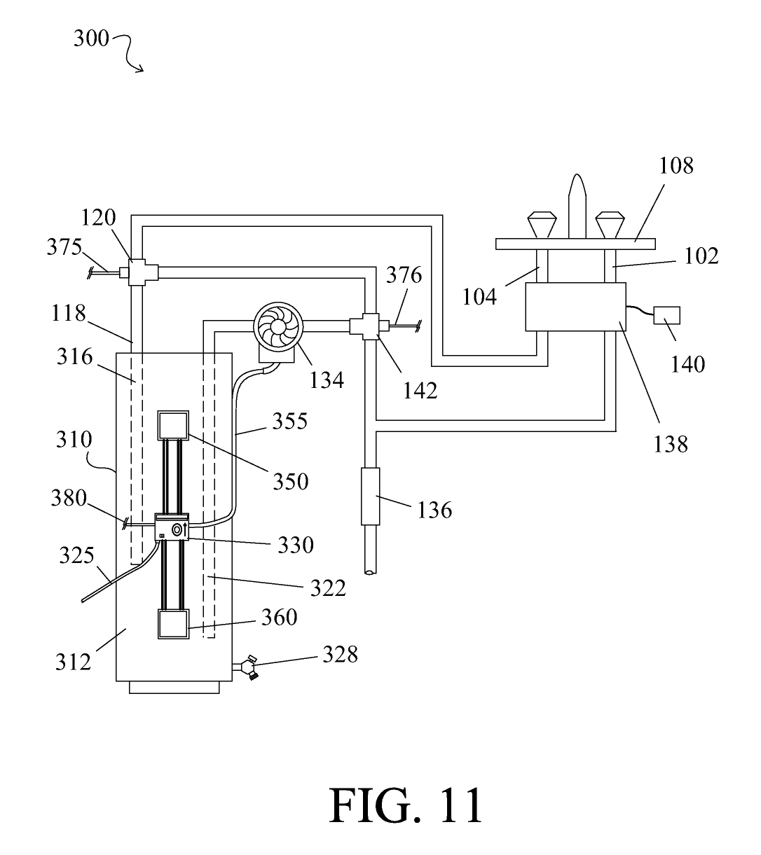

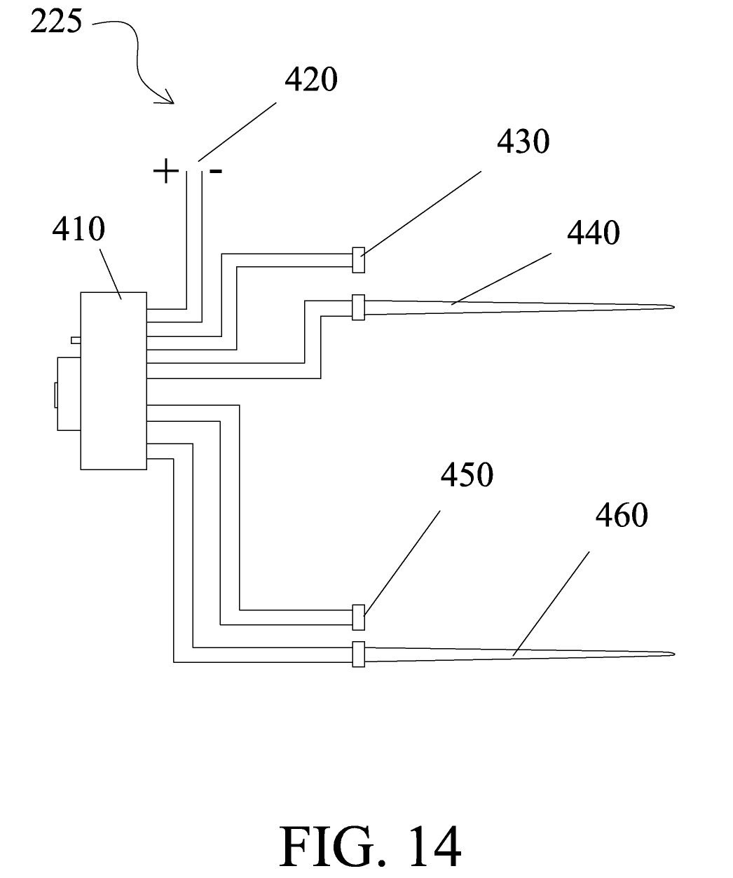

Referring now to FIGS. 11 and 14, an instant hot water delivery system is shown retrofitted to an electric hot water heater 310. A control unit 330 fits within a tank 312 in place of the factory installed control (not shown). Control unit 330 is in electrical communication with an upper heating unit 350 that contains a heating element 440 and a temperature sensor 430 and a lower heating unit 360 with a heating element 460 and temperature sensor 450. In use, heating elements 440 and 460 respectively turn on and off in response to control signals from control unit 330 which is fed temperature information from sensors 430 and 450. Additionally, recirculation pump is controlled by control unit 330 as discussed above. Recirculation pump 134 is controlled by an electrical connection 355 to control unit 330.

Also, again as discussed above, first and second three-way valves 120 and 142 respectively, are controlled through electrical connections 375 and 376 and connected to control unit 330 through connection 380. Also shown but with analogous function as discussed above are first dip tube 316, second dip tube 322, and drain valve 328.

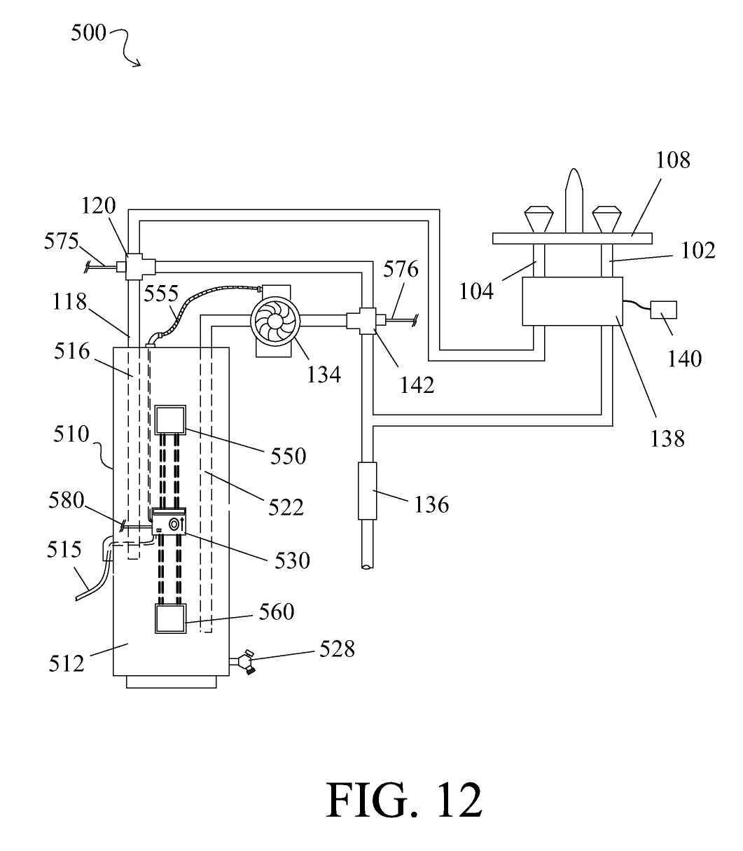

Referring to FIG. 12, a factory installed instant hot water delivery system is shown having a hot water heater 510 that utilizes a tank 512 with recirculation pump wiring 555 installed within tank 512. An electric feed 515 is provided to power a control unit 530. Control unit 530 has an upper heating/temperature sensor unit 550 and a lower heating/temperature sensor as discussed above. A drain valve 528, first dip tube 516 and second dip tube 522 are also provided as discussed above.

Also, again as discussed above, first and second three-way valves 120 and 142 respectively, are controlled through electrical connections 575 and 576 and connected to control unit 3530 through connection 580.

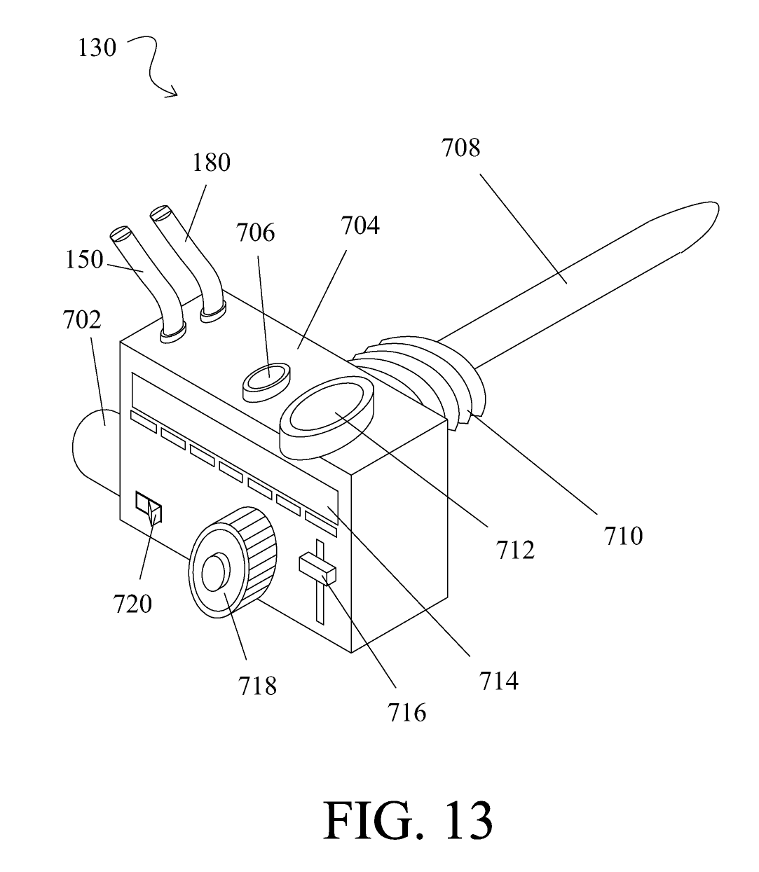

FIG. 13 is a perspective view showing the basic components of control unit 130. Control unit 130 has a housing 704 that contains the necessary electrical control components as discussed above. In the embodiment shown, a pilot light enable button is provided to allow a user to light a pilot light (not shown) as is known in the art. A gas valve 712 controls the flow of gas. A user display 714 is used to display information to the user such as scheduling information, water temperature, etc. A slide switch 716 is provided to allow a user to change the temperature or other user defined settings. A control knob 718 is also provided to allow user input.

A power switch 720 is used to turn control unit 130 on and off. A gas connection port 702 is provided to allow connection with a gas supply (not shown). A temperature sensor 708 is fitted within a tank (not shown) to provide temperature information to control unit 130. A threaded portion 710 allows control unit 130 to be fitted within tank (not shown). Electric feed 150 provides the necessary power to control unit 130. Of course it is understood that the user interface shown is merely representative and no particular knob, slider, etc. is essential; rather, the important point is that control unit 130 be addressable, either by the user or preset in the factory. It is understood that user interfaces could include touch screen, wireless remote or other suitable interface as is known in the art.

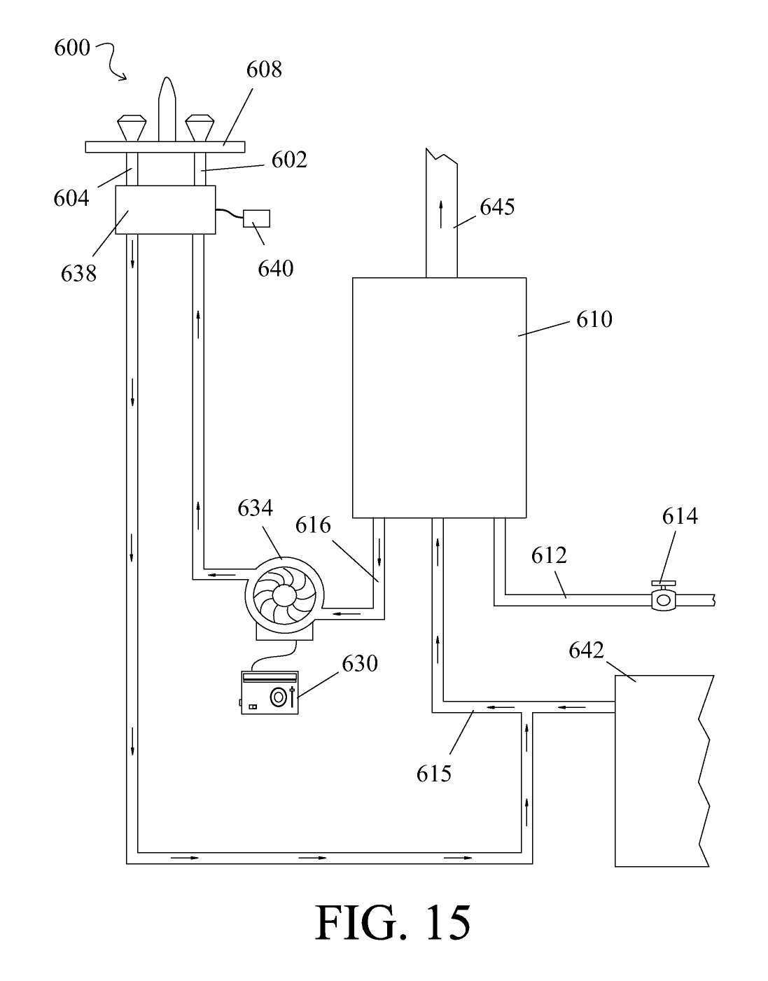

With reference to FIG. 15, an instant hot water delivery system 600 is shown in a tankless embodiment having a tankless heating unit 610 with an exhaust pipe 645 to vent combustion products. Of course an electric unit would not require and exhaust pipe. A gas valve 614 and gas supply line 612 is provided to supply gas to heater (not shown) within tankless heating unit 610. A cold water supply 642 supplies cold water to system 600 through cold water in line 615. A recirculation pump 634 is provided to control the flow of water as discussed above. A control unit 630 provides the functionality to control system 600 to allow instant delivery of hot water to a faucet 608. A cold water supply line 602 allows cold water to flow through faucet 608. A hot water supply line 604 is provided to provide hot water to faucet 608. A bypass valve 638 works in conjunction with a pump enable valve 640 which functions basically the same as discussed above. A cold water out line 616 feeds water to recirculation pump.

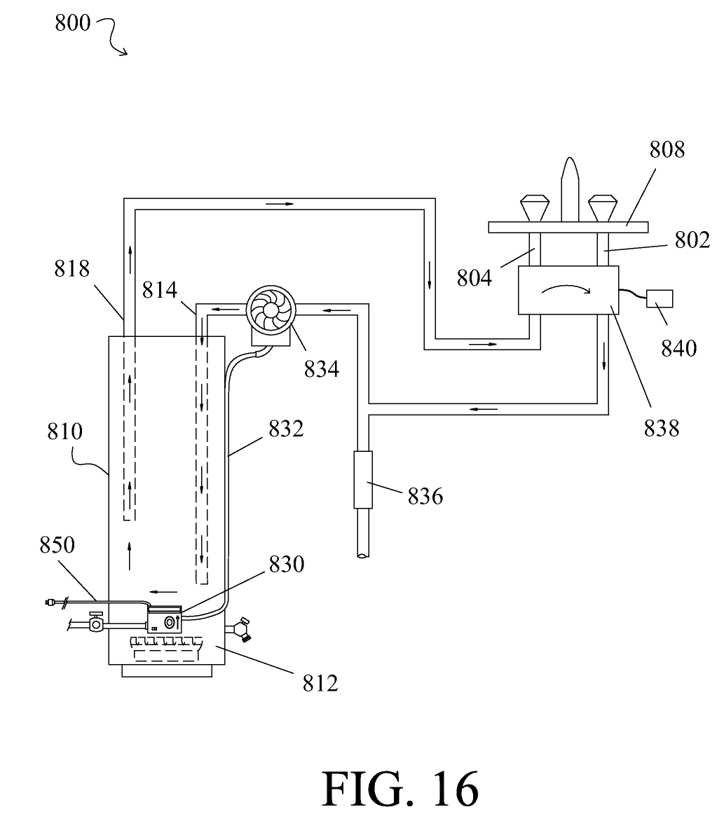

Now referring to FIG. 16, an instant hot water delivery system 800 is shown in without a local recirculation loop and comprises a water heater 810 having a tank 810. Tank 810 has an inlet 814 and outlet 818, a cold water supply line 802 introducing cold water into the inlet 814, a hot water supply line 804 connecting the outlet 818 to a faucet 808. A recirculation pump 834 is controlled by recirculation pump wiring 832 and is connected to the cold water supply line 102 through a bypass valve 838. Bypass valve 838 is controlled by a pump enable valve 840. A check valve 836 is provided to prevent water from flowing back. This embodiment does not require three-way valves. Also provided is a control unit 830 that is powered through an electric in 850. This system 800 operates in a similar manner as discussed in reference to the system shown in FIGS. 7-9, however, since it lacks the local recirculation loop, it is simpler to install and operate. While less efficient, it is acceptable and provides instant hot water as discussed above.

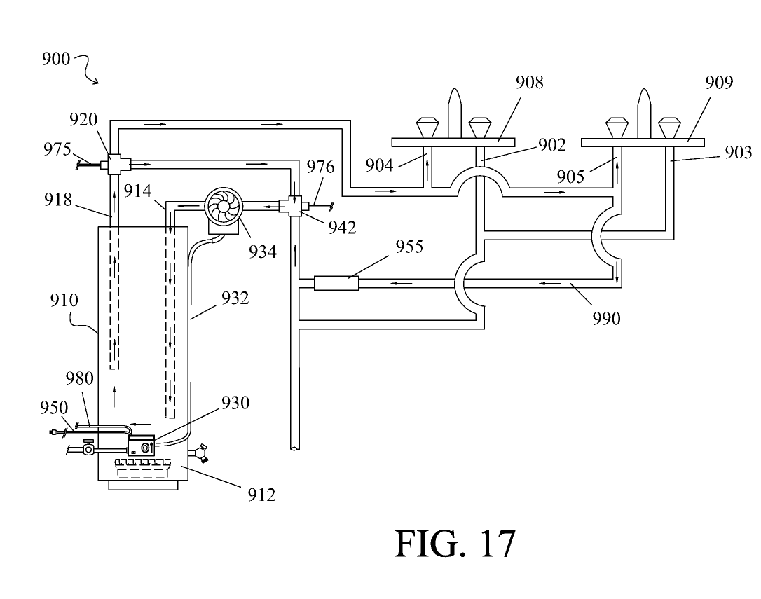

Referring now to FIG. 17, an instant hot water delivery system 900 is shown in a pre-plumbed embodiment. A plurality of water outlets may be represented, but for simplicity only two are shown. A faucet 909 is shown as being at the farthest end of the hot water run and includes cold water supply line 903, hot water supply line 905. Another representative faucet 908 is shown also having a cold water supply line 902 and hot water supply line 904. No bypass valve is required. As discussed above, a hot water heater 910 includes a tank 910, inlet 914 and outlet 918. A recirculation pump 934 is controlled by a control unit 930 connected by recirculation wiring 932. A first three-way valve 920 is controlled through an electrical connection 975 to control unit 930 and a second three-way valve 942 is controlled through an electrical connection 976 to control unit 930. Control unit 930 includes an electrical connection 980 that connects to valves 920 and 942 respectively. Again as discussed above, this electrical connection could be wireless. An electric in 950 is provided to power control unit 930.

A check valve 955 only allows the water to flow in the direction shown. A hot water recirculation line 990 is pre-plumbed.

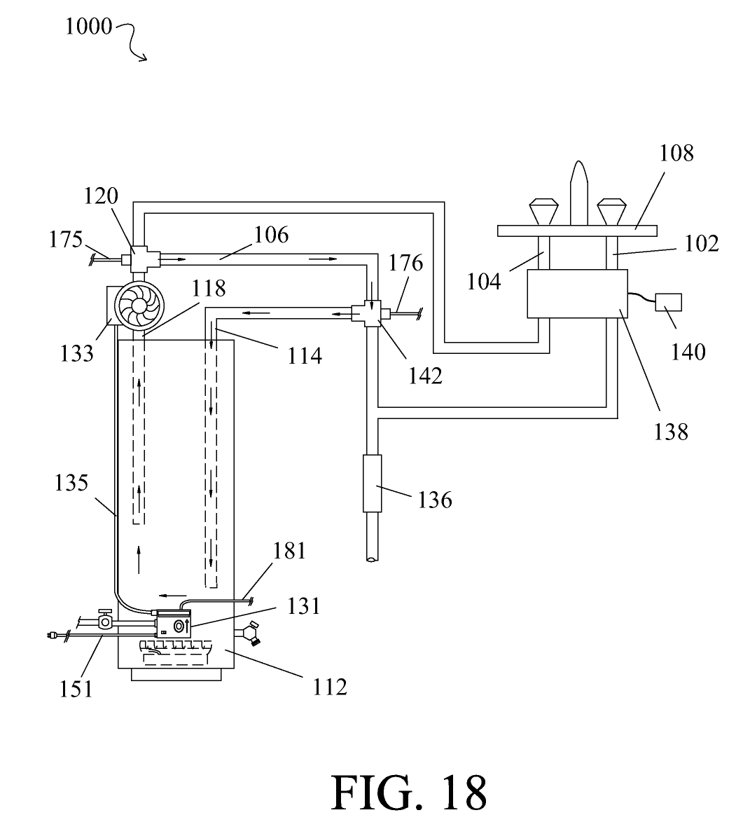

With reference to FIG. 18, an instant hot water delivery system 1000 is shown having a recirculation pump 133 in an alternative location. Recirculation pump 133 is located on outlet 118 and is controlled as before by a connection 135 to a control unit 131. As discussed above, an electrical connection 181 is provided to control three-way valves 120 and 142 respectively.

Also, although in the embodiment shown, the control unit is shown having an external power feed, it is understood that all that is required is that the control unit be supplied with an appropriate power source. Other suitable sources, while not exhaustive, could include batteries, solar panels, etc. as is known in the art.

Although the instant invention has been described in relation to particular embodiments thereof, many other variations and modifications and other uses will become apparent to those skilled in the art.

What is claimed is:

1. An instant hot water delivery system, comprising:
a water heater including as inlet and an outlet;
a cold water supply line introducing cold water into said inlet;
a hot water supply line connecting said outlet to a faucet;
a recirculation line connected to said hot water supply downstream of said outlet and said cold water supply line upstream of said inlet, wherein said recirculation line forms a first recirculation loop for water within said water heater to flow during a first water heating process;
a recirculation pump connected to said cold water supply line between said local recirculation line and said inlet for circulating said water during aid first water heating process; and
a control means for controlling said recirculation pump.

2. The instant hot water delivery system according to claim 1 wherein said control means is adapted as a retrofit control for said water heater.

3. The instant hot water delivery system according to claim 2 wherein said water heater is a gas water heater.

4. The instant hot water delivery system according to claim 2 wherein said water heater is an electric water heater.

5. The instant hot water delivery system according to claim 2 wherein said control means comprises a computer processor adapted to run a selected algorithm.

6. The instant hot water delivery system according to claim 5 wherein said control means comprises an electronic control valve that responds to a control signal provide therein.

7. The instant hot water delivery system according to claim 2 wherein said water heater is a tankless water heater.

8. The instant hot water delivery system according to claim 2 wherein said control means comprises:
at least one thermostat;
an electronically controlled gas valve; and
a power switch; wherein said at least one thermostat is adapted to feed temperature information to a processor contained therein wherein said processor is in electrical communication with said electronically controlled gas valve and said power switch.

9. The instant hot water delivery system according to claim 1 also comprising a three-way valve interconnecting said recirculation line to said hot water supply line.

10. The instant hot water delivery system according to claim 9 wherein said three-way valve toggles between a fluid connection of said outlet to said faucet via said hot water supply line or said recirculation pump via recirculation line in response to a command signal from said control means.

11. The instant hot water delivery system according to claim 1 also comprising a check valve interconnected along said cold water supply line upstream of said recirculation line.

12. The instant hot water delivery system according to claim 1 wherein said recirculation pump includes a flow sensor.

13. The instant hot water delivery system according to claim 9 wherein said three-way valve further comprises a valve temperature sensor therein.

14. The instant hot water delivery system according to claim 13 wherein said three-way valve toggles between a fluid connection of said outlet to said faucet via said hot water supply line or said recirculation pump via recirculation line in response to a selected temperature as indicated by said valve temperature sensor.

15. The instant hot water delivery system according to claim 1 further comprising a bypass valve interconnecting said cold water supply line and said hot water supply line.

16. The instant hot water delivery system according to claim 15 wherein said bypass valve includes a bypass temperature sensor.

17. The instant hot water delivery system according to claim 15 wherein said bypass valve is controlled by said control means.

18. The instant hot water delivery system according to claim 16 wherein said bypass valve is controlled in response to a selected temperature as indicated by said bypass temperature sensor.

19. A method of providing nearly instant hot water to a faucet in an existing hot water heating system comprising the steps of:
removing an existing control unit/thermostat from a water heater;
obtaining an instant hot water delivery system control unit;
connecting said instant hot water delivery system control unit to said existing hot water heater;
forming at least one recirculation loop between a cold water supply line and a hot water supply line;
connecting a recirculation pump within said at least one recirculation loop wherein said recirculation pump is controlled by said instant hot water delivery system control unit;
setting a heating schedule to said instant hot water delivery system control unit;
directing a flow of water through said at least one recirculation loop according to said heating schedule;
closing said at least one recirculation loop when said flow of water reaches a predetermined temperature;
directing said flow of water through said hot water supply line to a faucet; and
receiving nearly instantly hot water through said faucet.

20. A method of providing nearly instant hot water to a faucet comprising the steps of:
obtaining a hot water heater equipped with an instant hot water delivery system control unit;
forming at least one recirculation loop between a cold water supply line and a hot water supply line;
connecting a recirculation pump within said at least one recirculation loop wherein said recirculation pump is controlled by said instant hot water delivery system control unit;
setting a heating schedule to said instant hot water delivery system control unit;
directing a flow of water through said at least one recirculation loop according to said heating schedule;
closing said at least one recirculation loop when said flow of water reaches a predetermined temperature;
directing said flow of water through said hot water supply line to a faucet; and
receiving nearly instantly hot water through said faucet.
